(19) United States
(12) Patent Application Publication
(10) Pub. No.: US 2009/0190783 A1
(43) Pub. Date: Jul. 30, 2009

(54) SPEAKER SET FOR PORTABLE ELECTRONIC DEVICE

(75) Inventors: TSUNG-LUNG YANG, Shindian (TW); PEI-RONG LI, Shenzhen City (CN); WEN-YUN ZHAO, Shenzhen City (CN); XING-XIONG DENG, Shenzhen City (CN)

Correspondence Address: PCE INDUSTRY, INC.;ATT. Steven Reiss, 458 E. LAMBERT ROAD, FULLERTON, CA, 92835, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/339,233

(22) Filed: Dec. 19, 2008

(30) Foreign Application Priority Data
Jan. 24, 2008 (CN) 200810300217.9

(51) Int. Cl. H04R 1/20

(52) U.S. Cl. 381/337

(57) ABSTRACT

A speaker set includes a hollow shell, a back cover, and a loudspeaker. The shell includes at least one partition wall dividing an inner space of the shell into a first chamber, a second chamber, and a third chamber. The loudspeaker is packaged between the shell and the back cover. The loudspeaker is accommodated in the first chamber, and divides the first chamber into a front sub-chamber and a rear sub-chamber. The front and rear sub-chambers respectively communicate with the second and third chambers thereby forming a front resonance chamber and a rear resonance chamber respectively. The loudspeaker has a plurality of front tone holes and a plurality of rear tone holes respectively communicating with the front sub-chamber and the rear sub-chamber. The front resonance chamber communicates with a surrounding environment so that sound waves emanating from the front tone holes can be transmitted to the surrounding environment.

### BACKGROUND

1. Technical Field

The present invention relates generally to speaker sets for portable electronic devices, and more particularly to a speaker set which gives a portable electronic device incorporating a speaker set of compact size and good sound quality.

2. Description of the Related Art

Portable electronic devices, such as mobile phones, CD players, MP3 players, personal digital assistants (PDAs) and the like, have decreased both in size and weight over the past few years and are becoming ever more popular with travelers. This demand for smaller size with ever-increasing capability has required tremendous efforts to continually shrink many of the components contained within the device.

In another aspect, portable electronic devices being designed today require multi-media features and provide the user with the same enjoyable experience as that experienced with conventional high quality desktop systems. Thus, the sounds emanating from a portable electronic device should provide as full a harmonic content as the original sounds. The production of high frequency sounds requires a large acoustic chamber for the movement of a large mass of air. As the device is reduced in size, the size of the acoustic chamber of the speaker set and the maximum power the speaker can handle are also accordingly reduced, resulting in both a reduction in loudness as well as a poorer overall quality of sound.

For example, as shown in FIG. 7, a speaker set 100 for portable electronic devices includes a housing 10 and a speaker 19 incorporated in the housing 10. The housing 10 has a top surface 11, a sidewall 13 extending upwards from the top surface 11, and a cavity 15 defined between the top surface 11 and the sidewall 13. A plurality of sound propagation holes 110 is defined in the top surface 11, and communicates with the cavity 15. The speaker 19 has a sound emanating surface 191. The speaker 19 is received in the cavity 15, with the sound emanating surface 191 thereof facing towards the top surface 11. An acoustic chamber is thus formed by the sound emanating surface 191 of the speaker 19 and the housing 10. Since the sound emanating surface 191 of the speaker 19 is disposed close to the top surface 11 of the housing 10, the acoustic chamber is small.

However, increasing the device size to increase the size of the acoustic chamber for the speaker set is very undesirable since it would strongly detract from the very characteristics that have helped to make these devices popular, namely size and weight. Thus the size of the device is at odds with high capability sounds of the speaker set. Therefore, there is room for improvement with the art.

### BRIEF DESCRIPTION OF THE DRAWINGS

Many aspects of the present speaker set for portable electronic device can be better understood with reference to the following drawings. The components in the drawings are not necessarily drawn to scale, the emphasis instead being placed upon clearly illustrating the principles of the present speaker set and its potential applications. Moreover, in the drawings, like reference numerals designate corresponding parts throughout the several views.

FIG. 1 is a schematic, disassembled view of a speaker set according to a present embodiment.

FIG. 2 is an assembled schematic view of the speaker set of FIG. 1, without incorporating a back cover thereof.

FIG. 3 is an assembled schematic view of the speaker set of FIG. 1, with the back cover being mounted thereon.

FIG. 4 shows a cross-sectional view of the speaker set, taken along line IV-IV of FIG. 3.

FIG. 5 is a disassembled schematic view of a speaker set according to another embodiment.

FIG. 6 shows a cross-sectional view of the speaker set of FIG. 5.

FIG. 7 shows a schematic, cross-sectional view of a typical speaker used in a mobile phone.

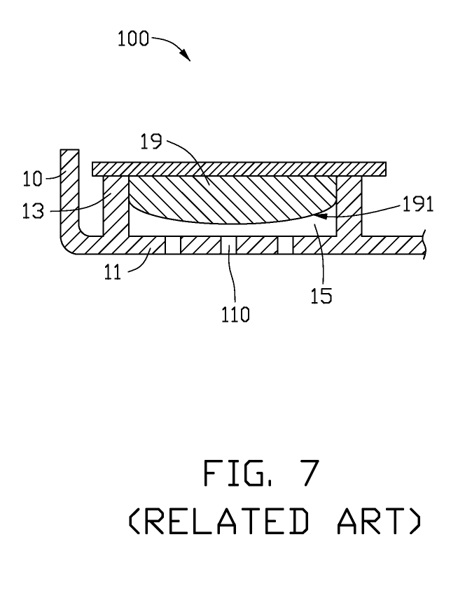

### DETAILED DESCRIPTION OF THE PREFERRED EMBODIMENT

The present speaker set is particularly suitable for portable electronic devices, such as mobile phones, PDAs, and the like, but could find other applications in which a speaker set is employed.

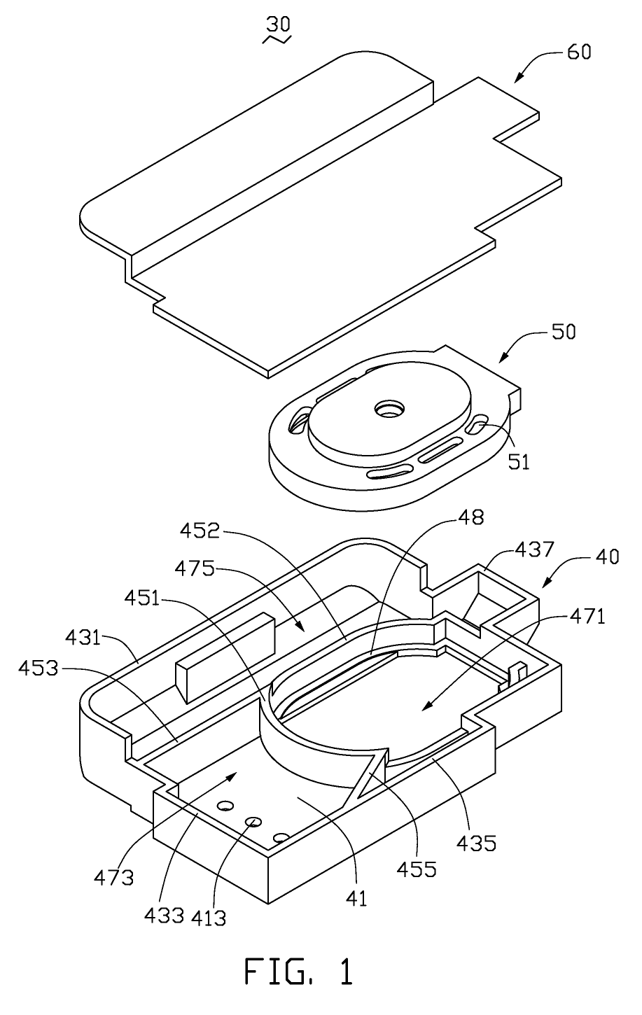

Referring to FIG. 1, a speaker set 30 according to a first exemplary embodiment includes a hollow shell 40, a loudspeaker 50 accommodated in the shell 40, and a back cover 60 mounted on the hollow shell 40 to package the loudspeaker 50 between the shell 40 and the back cover 60.

The shell 40 is preferably made of anti-vibration material, to prevent the shell 40 resonating with the loudspeaker 50, thereby improving the quality of sound of the speaker set 30. The shell 40 is open on one side, and includes a base wall 41, a plurality of sidewalls, e.g. a first sidewall 431, a second sidewall 433, a third sidewall 435, and a fourth sidewall 437, approximately perpendicularly extending from an outer periphery of the base wall 41, a plurality of partition walls, e.g. a first partition wall 451, a second partition wall 453, and a third partition wall 455, perpendicularly extending from a middle portion of the base wall 41, and a supporting member 47.

The base wall 41 is approximately rectangular. The first, second, third and fourth sidewalls 431, 433, 435, 437 are projected along the outer periphery of the base wall 41 in order. That is, the first and third sidewalls 431, 435 are disposed towards to each other, the second and fourth sidewalls 433, 437 are disposed towards to each other and both connect with the first and third sidewalls 431, 435. The base wall 41 has at least one sound propagation port 413 defined therein. The sound propagation port 413 can be, but is not limited to, a hole, a slot, and a slit.

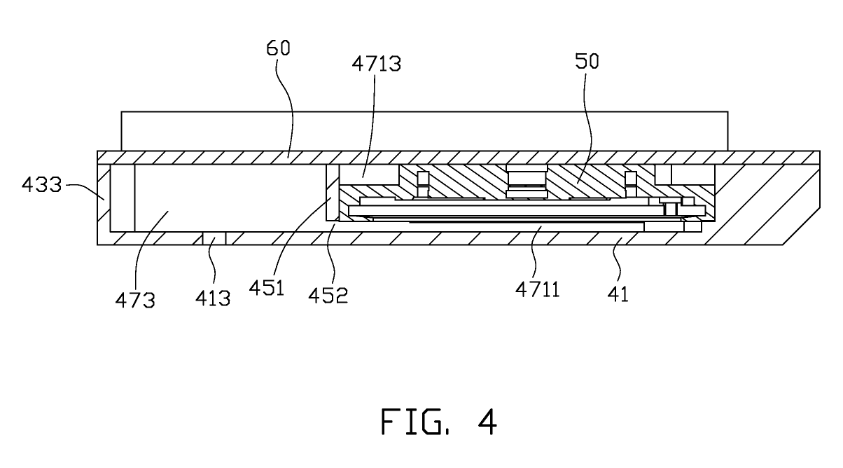

The first partition wall 451 can be round (e.g., elliptical), and connects to two adjacent sidewalls. In the first exemplary embodiment, the first partition wall 451 connects with the third and fourth sidewalls 435, 437. The first partition wall 451 further defines two communicating ports 452. The communicating ports 452 can be, but are not limited to, a hole, a slot, a slit, a groove, and a notch. Referring to FIG. 4, one communicating port 452 is defined towards the second sidewall 433, and is defined near to the base wall 41. Back to FIG. 1, the other communicating port 452 is defined towards the first sidewall 431, on the top of the first partition wall 451. The second partition wall 453 is disposed approximately parallel with the first sidewall 431, and has two opposite ends respectively connecting to the first partition wall 451 and the second sidewall 433. The third partition wall 455 has two opposite ends respectively connecting to the first partition wall 451 and the third sidewall 435. The communication port 452 is defined between the second and third partition walls 453, 455.

The partition walls divide a space formed between the base wall 41 and the sidewalls 431, 433, 435, 437 into sub-chambers, e.g. a first resonance chamber 471, a second resonance chamber 473, and a third chamber 475. The first resonance chamber 47 comprises the free space between the first partition walls 451, the fourth sidewall 437, and the base wall 41. The first resonance chamber 471 receives the loudspeaker 50 therein. The second resonance chamber 473 comprises the free space between the first, second and third partition walls 451, 453, 455, the second and third sidewall 433, 435 and the base wall 41. The third resonance chamber 475 comprises the free space between the first and second partition walls 451, 453, the first, second and fourth sidewalls 431, 433, 437, and the base wall 41. The second and third resonance chambers 473, 475 both communicate with the first resonance chamber 471 through a corresponding communicating port 452. The sound propagation port 413 of the base wall 41 is placed in the second resonance chamber 453, thus the second resonance chamber 473 can communicate with the surrounding environment through the sound propagation port 413.

The supporting member 48 supports the loudspeaker 50 to separate the loudspeaker 50 from the base wall 41. In the present embodiment, the supporting member 48 is an elliptical flange projecting from the base wall 41, inside the first resonance chamber 471.

The loudspeaker 50 converts electrical signals to sound waves, and has a shape and size corresponding with that the shape and size of the first resonance chamber 471 so the loudspeaker 50 can be fittingly received in the first resonance chamber 471. The loudspeaker 50 has a diaphragm (not shown) that oscillates and generates sound waves, and defines a plurality of front tone holes (not shown) faces towards the base wall 41 and a plurality of rear tone holes 51 opposite to the front tone holes. The sound waves generated by the diaphragm are transmitted from the loudspeaker 50 through the front tone holes and the rear tone holes 51.

The back cover 60 covers the open side of the shell 40 and packages the loudspeaker 50 within the shell 40. The back cover 60 is mounted to the top of the sidewalls and partition walls so as to hermetically enclose the open side of the shell 40. The back cover 60 is preferred to be a printed circuit board, so that it can be electrically connected to the loudspeaker 50 to provide electric signals to the loudspeaker 50.

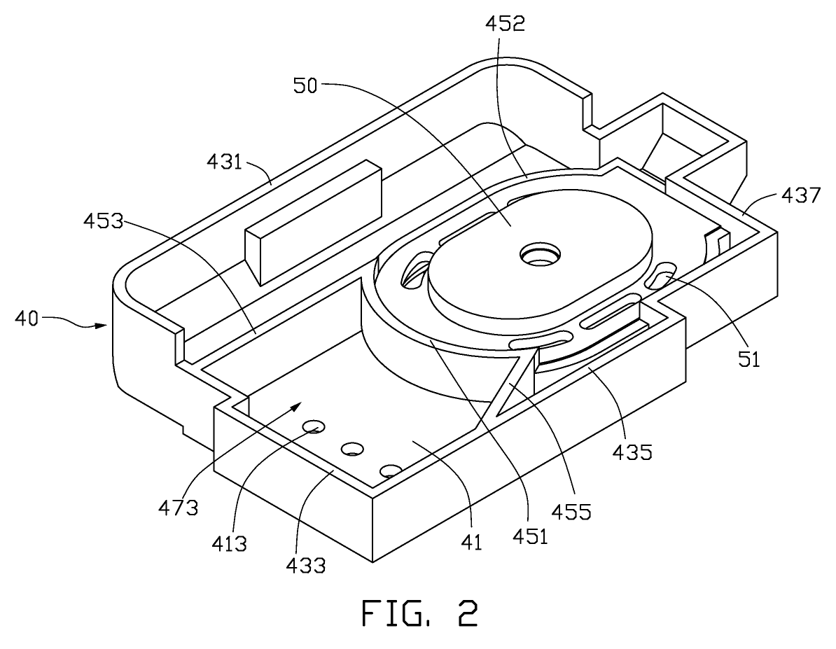

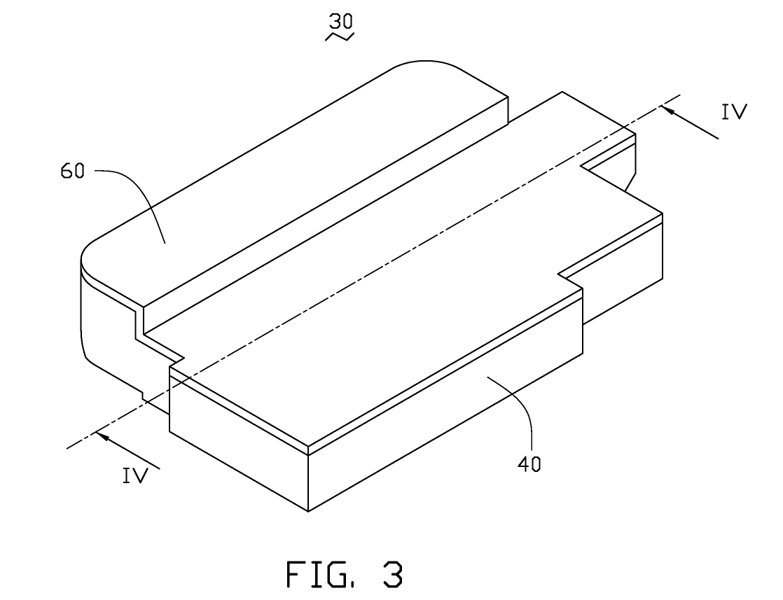

As regard to FIGS. 2-4, in assembly the speaker set 30, the loudspeaker 50 is placed inside the first resonance chamber 471 of the shell 40, and is supported and mounted on the supporting member 48. The front tone holes of the loudspeaker 50 face towards the base wall 41, and are spaced from the base wall 41 by the supporting member 48. The back cover 60 is hermetically connected with the open side of the shell 40. The loudspeaker 50 divides the first resonance chamber 471 into two isolated resonance sub-chambers, e.g., a front resonance sub-chamber 4711 (shown in FIG. 4) and a rear resonance sub-chamber 4713 (shown in FIG. 4), at two opposite sides thereof. The second resonance chamber 473 communicates with the front resonance sub-chamber 4711 through a corresponding communicating port 452, thus forming a front resonance chamber for the speaker set 30. The third resonance chamber 475 communicates with the rear resonance sub-chamber 4713 through a corresponding communicating port 452, thus forming a rear resonance chamber for the speaker set 30.

In use, sound waves emanated from the front tone holes of the loudspeaker 50 are transmitted to and resonate with air in the front resonance chamber, and then sound waves in the front resonance chamber are transmitted into the surrounding environment through the sound propagation port 413 of base wall 41. Sound waves emanated from the rear tone holes 51 of the loudspeaker 50 are transmitted to and resonate with air in the rear resonance chamber, and thus boosting the low frequency sound and improving the sound quality of the speaker set 30.

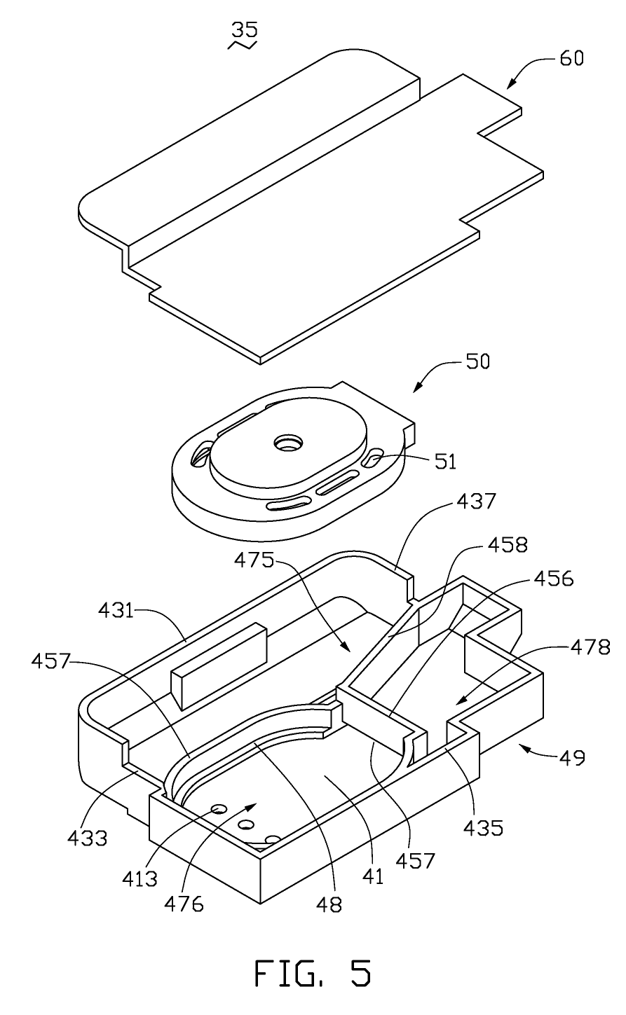

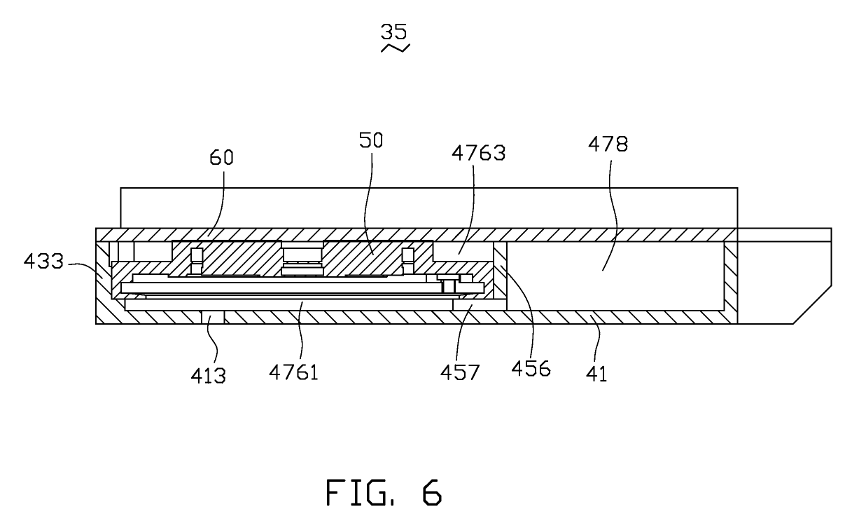

As regards to FIGS. 5 and 6, a speaker set 35 according to a second exemplary embodiment is illustrated. The speaker set 35 has a similar structure to the speaker set 30 and includes a shell 49, a loudspeaker 50 and a back cover 60. The speaker set 35 differs from the speaker set 30 primarily in the structure of the shell 49. The shell 49 includes a base wall 41, a plurality of sidewalls 431, 433, 435, 437, a plurality of partition walls, i.e., a first partition wall 456, and a second partition wall 458, and a supporting member 48. The base wall 41, sidewalls 431, 433, 435, 437, and the supporting member 48 are structured similarly to those of the speaker set 30. The first partition wall 456 has a similar structure to the first partition wall 451 and defines two communicating ports 457 therein. The first partition wall 456 differs from the first partition wall 451 mainly in its position. In the second exemplary embodiment, the first partition wall 456 is positioned at a corner formed by the second and third sidewalls 433, 435, and connects to the second and third sidewalls 433, 435. The second partition wall 458 connects both to the first partition wall 456 and the fourth sidewall 437. Therefore, the partition walls 456, 458 divide the space in the shell 49 into three sub-chambers, i.e., a first resonance chamber 476, a second resonance chamber 478, and a third resonance chamber 475. The first resonance chamber 476 is formed between the first partition wall 456 and the base wall 41. The second resonance chamber 478 is formed between the first and second partition walls 456, 458, the third and fourth sidewall 435, 437, and the base wall 41. The sound propagation port 413 of the base wall 41 is defined in the first resonance chamber 476. The second and third sound resonance chambers 478, 475 communicate with the first resonance chamber 476 through a corresponding communicating port 457.

In assembly the speaker set 35, the loudspeaker 50 is placed inside the first resonance chamber 476 of the shell 49, and is supported and mounted on the supporting member 48. The front tone holes of the loudspeaker 50 face towards the base wall 41, and are spaced from the base wall 41 by the supporting member 48. The back cover 60 is hermetically connected with the open side of the shell 40. The loudspeaker 50 divides the first resonance chamber 476 into two isolated resonance sub-chambers, e.g., a front resonance sub-chamber 4761 (shown in FIG. 6) and a rear resonance sub-chamber 4763 (shown in FIG. 4), at two opposite sides thereof. The second resonance chamber 478 communicates with the front resonance sub-chamber 4761 through a corresponding communicating port 452, thus forming a front resonance chamber for the speaker set 35. The third resonance chamber 475 communicates with the rear resonance sub-chamber 4763 through a corresponding communicating port 452, thus forming a rear resonance chamber for the speaker set 35.

In use, sound waves emanated from the front tone holes of the loudspeaker 50 are transmitted to and resonate with air in the front resonance chamber, and then sound waves in the front resonance chamber are transmitted into the surrounding environment through the sound propagation port 413 of base wall 41. Sound waves emanated from the rear tone holes 51 of the loudspeaker 50 are transmitted to and resonate with air in the rear resonance chamber, and thus boosting the low frequency sound and improving the sound quality of the speaker set 35.

It is to be understood, however, that even though numerous characteristics and advantages of the present invention have been set forth in the foregoing description, together with details of the structure and function of the present invention, the disclosure is illustrative only, and changes may be made in detail, especially in matters of shape, size, and arrangement of parts within the principles of present invention to the full extent indicated by the broad general meaning of the terms in which the appended claims are expressed.

What is claimed is:

1. A speaker set configured for a portable electronic device comprising:
a hollow shell comprising at least one partition wall dividing an inner space of the shell into a first chamber, a second chamber and a third chamber;
a back cover; and
a loudspeaker packaged between the shell and the back cover, the loudspeaker being accommodated in the first chamber, dividing the first chamber into a front sub-chamber and a rear sub-chamber, the front sub-chamber communicating with the second chamber thereby forming a front resonance chamber, the rear sub-chamber communicating with the second chamber thereby forming a rear resonance chamber, the loudspeaker having a plurality of front tone holes communicating with the front sub-chamber and a plurality of rear tone holes communicating with the rear sub-chamber, the front resonance chamber communicating with a surrounding environment so that sound waves emanating from the front tone holes can be transmitted to the surrounding environment.

2. The speaker set as claimed in claim 1, wherein the shell further comprises a base wall and a plurality of sidewalls surrounding a periphery of the base wall, and the at least one partition walls extend from a middle portion of the base wall.

3. The speaker set as claimed in claim 2, wherein the at least one partition walls comprise a first partition wall, and the first chamber is surrounded by the first partition wall.

4. The speaker set as claimed in claim 3, wherein the first partition wall has a round shape, and connects with two adjacent sidewalls.

5. The speaker set as claimed in claim 4, wherein the at least one partition walls comprise a second partition wall connects both with the first partition wall and a sidewall to form the second and third chambers.

6. The speaker set as claimed in claim 4, wherein the first partition wall defines two communicating ports therein to communicate the first chamber with the second and third chambers.

7. The speaker set as claimed in claim 6, wherein the two communicating ports are defined in two opposite side of the first partition wall, and the communicating port communicating the first and the second chambers is defined near to the base wall.

8. The speaker set as claimed in claim 2, wherein the base wall defines a sound propagation port therein to allow the front resonance chamber to communicate with the surrounding environment.

9. The speaker set as claimed in claim 8, wherein the sound propagation port is defined in one of the first and the second chambers.

10. The speaker set as claimed in claim 1, wherein the shell further has a supporting member disposed inside the first chamber to support and separate the loudspeaker from the base wall.

11. The speaker set as claimed in claim 10, wherein the supporting member is a flange projects from the base wall, along the periphery of the first chamber.
